(19) United States
(12) Patent Application Publication
(10) Pub. No.: US 2020/0271504 A1
(43) Pub. Date: Aug. 27, 2020

(54) METHODS AND APPARATUS FOR A CAPACITIVE SENSOR

(71) Applicant: SEMICONDUCTOR COMPONENTS INDUSTRIES, LLC, Phoenix, AZ (US)

(72) Inventors: Hiroshi YOSHINO, Oizumi-machi (JP); Takayasu OTAGAKI, Ota (JP)

(73) Assignee: SEMICONDUCTOR COMPONENTS INDUSTRIES, LLC, Phoenix, AZ (US)

(21) Appl. No.: 16/455,075

(22) Filed: Jun. 27, 2019

Related U.S. Application Data
(60) Provisional application No. 62/811,178, filed on Feb. 27, 2019.

(51) Int. Cl. G01F 23/26

(52) U.S. Cl. CPC G01F 23/268; G01F 23/266

(57) ABSTRACT

Various embodiments of the present technology may provide methods and apparatus for a capacitive sensor. The methods and apparatus may provide a capacitive sensor formed along multiple planes of a container to create a sensing field. The capacitive sensor provides a first electrode affixed to the container and extending from a horizontal bottom plate of the container to a vertical side plate of the container and a second electrode affixed to the vertical side plate of the container and spaced apart from the first electrode.

### CROSS-REFERENCE TO RELATED APPLICATIONS

This application claims the benefit of U.S. Provisional Patent Application No. 62/811,178, filed on Feb. 27, 2019, the entire contents of which is incorporated herein by reference.

### BACKGROUND OF THE TECHNOLOGY

Capacitive sensors operate by detecting changes in the capacitance formed between two electrodes, commonly referred to as a transmission electrode and a sense electrode. A sensing circuit can recognize an object and may be configured to determine the location, pressure, direction, speed, and acceleration of the object as it is approaches and/or contacts the capacitive sensor.

Capacitive sensors may also be utilized to detect a volume and/or a level of a substance, such as fluids or powders, within a container. In this application, the sensing circuit detects changes to the capacitance of the capacitive sensor as the level of the substance in the container changes. Capacitive sensors utilized in such applications may provide a more accurate measurement and may be more reliable and less expensive than conventional indicators.

### SUMMARY OF THE INVENTION

Various embodiments of the present technology may provide methods and apparatus for a capacitive sensor. The methods and apparatus may provide a capacitive sensor formed along multiple planes of a container to create a sensing field. The capacitive sensor provides a first electrode affixed to the container and extending from a horizontal bottom plate of the container to a vertical side plate of the container and a second electrode affixed to the vertical side plate of the container and spaced apart from the first electrode.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 is a circuit diagram of a capacitive sensor system in accordance with an exemplary embodiment of the present technology;

FIG. 2 illustrates a perspective view of a container used in conjunction with the capacitive sensor system in accordance with an exemplary embodiment of the present technology;

FIG. 3 illustrates a cross-sectional view of the container of FIG. 2 and in accordance with an exemplary embodiment of the present technology;

FIG. 4 illustrates a cross-sectional view of a container used in conjunction with the capacitive sensor system in accordance with an alternative embodiment of the present technology;

FIG. 5 is a graph illustrating a change in a first capacitance versus a change in liquid level in accordance with the embodiment of FIG. 3;

FIG. 6 is a graph illustrating a change in a second capacitance versus a change in liquid level in accordance with the embodiment of FIG. 4;

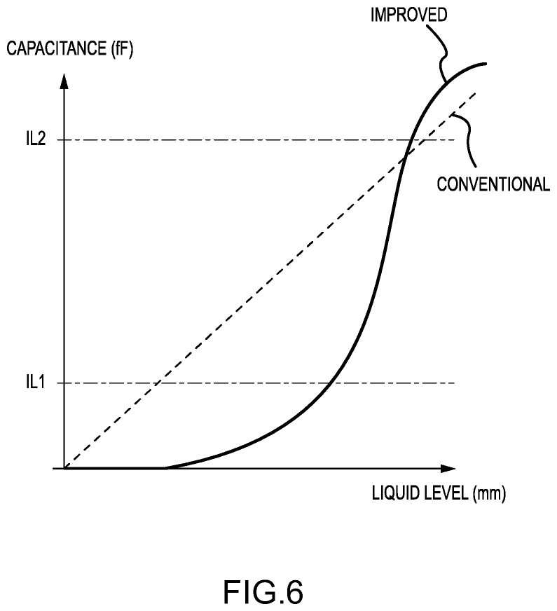

FIG. 7 illustrates a cross-sectional view of a container used in conjunction with the capacitive sensor system in accordance with a third embodiment of the present technology; and

FIG. 8 is a graph illustrating a change in third capacitance versus a change in liquid level in accordance with the embodiment of FIG. 7.

### DETAILED DESCRIPTION OF EXEMPLARY EMBODIMENTS

The present technology may be described in terms of functional block components and circuit diagrams. Such functional blocks and circuit diagrams may be realized by any number of components configured to perform the specified functions and achieve the various results. For example, the present technology may employ various types of capacitors, amplifiers, signal converters, switching devices, power sources, and the like, which may carry out a variety of functions. The methods and apparatus for a capacitive sensor according to various aspects of the present technology may operate in conjunction with any suitable system, such as a printer system or any other system that monitors an amount of a substance in a container.

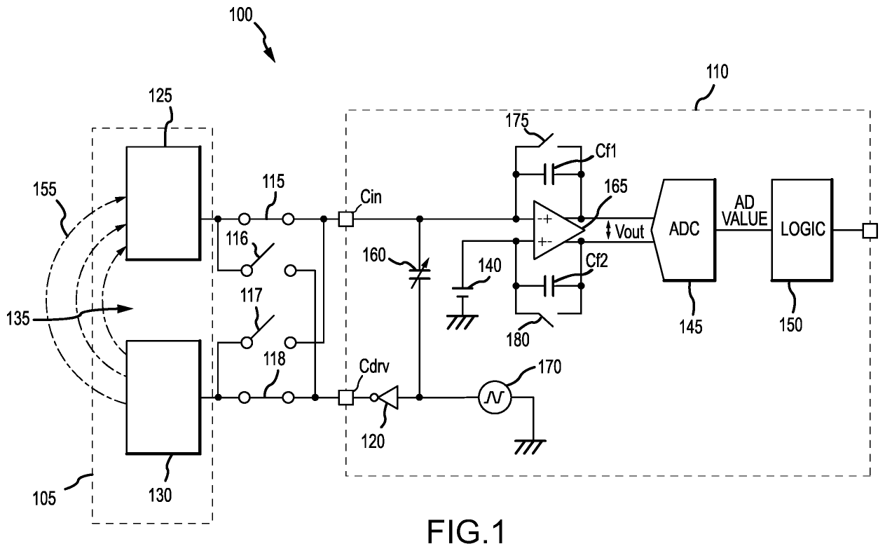

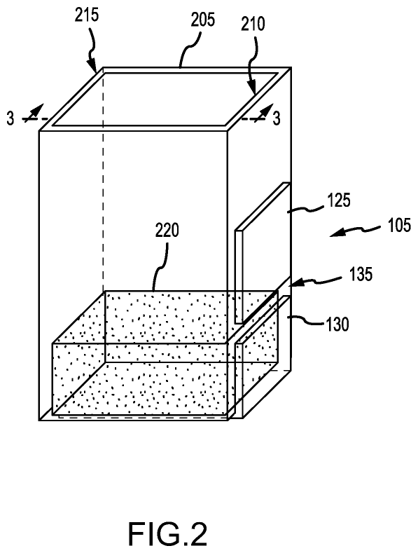

Referring to FIGS. 1 and 2, in various embodiments of the present technology, a sensor system 100 may detect an amount (or level) of a substance 220, such as a liquid or a powder, in a container 205. This may be achieved by affixing, either permanently or temporarily, a portion of the sensor system 100 to the container 205 and measuring a change in a capacitance and/or an output voltage (Vout) of the sensor system 100. In various embodiments, the sensor system 100 may comprise a capacitive sensor 105 and a detection circuit 110 that operate in conjunction with each other to measure changes in the capacitance of the capacitive sensor 105.

Referring to FIGS. 2-4, the container 205 may be configured to hold the substance 220 for a desired period of time. For example, the container 205 may comprise a bottom portion 325, such as a horizontal bottom plate, and at least one sidewall 320, such as a vertical sidewall (i.e., side plate), that extends upwards from the bottom portion 325. The container 205 may also comprise an interior region defined by an inner surface 210 of the sidewall 320 and the bottom portion 325, wherein the interior region holds the substance 220.

The container 205 may further comprise a first port (not shown) within or near the bottom portion 325 that allows for controlled release of the substance 220 out of the container 205. The container 205 may further comprise a second port (not shown) within or near a top plate 420, which that is substantially parallel with the bottom portion 325, that allows for adding the substance 220 to the container 205.

The container 205 may have predetermined dimensions, for example, in the case of a rectangular or square-shaped container, a height, a width, and a length. As such, the container 205 may have a maximum volume, equal to a product of the height, the width, and the length (i.e. volume=height×width×length). The container 205 may be filled with the substance 220, such as a liquid having with a predetermined dielectric constant, or a powder. Accordingly, the volume of the substance 220 may be computed based on the container dimensions, capacitance data, dielectric constant, and/or other relevant data.

The particular arrangement of the capacitive sensor 105 may be adapted according to a desired function or application. For example, the size and/or shape of the capacitive sensor 105 (electrodes) may be adapted to be affixed to containers of various shapes and sizes, such as a cylindrical-shaped container, a spherical-shaped container, and the like.

The first and second electrodes 130, 125 may be affixed to the interior region of the container 205, an outer surface 215 of the container 205, and/or integrated within one or more walls of the container 205.

In an alternative embodiment, the first and second electrodes 130, 125 may be positioned adjacent to the container 205, for example next to, but not in direct contact with, an outer surface 215 of the container 205.

Referring to FIGS. 1-3, the capacitive sensor 105 may generate an electric field, such as a first electric field 155, and may operate as a proximity sensor to detect and/or measure changes in the electric field based on an amount of the substance 220 in the container 205. In an exemplary embodiment, the capacitive sensor 105 may comprise a first electrode 130 and a second electrode 125 in communication with each other. For example, one electrode, such as the first electrode 130, may operate as a transmission electrode (i.e., a drive electrode) and the remaining electrode, such as the second electrode 125, may operate as a reception electrode (i.e., an input electrode), or vice versa.

The first and second electrodes 130, 125 may be configured to operate as either the transmission electrode or the drive electrode. For example, the sensor system 100 may comprise a plurality of switches, such as switches 115, 116, 117, and 118, connected between the capacitive sensor 105 and the detection circuit 110. Each switch may be selectively operated to connect the first electrode 130 to either a drive terminal Cdrv or an input terminal Cin and connect the second electrode 125 to the remaining terminal. The first and second electrodes 130, 125 may be formed within an insulation substrate (not shown), such as a PCB substrate, or a flexible plastic substrate (not shown).

According to various embodiments, the operation of the first and second electrodes 130, 125 may be sequenced, wherein at one time interval, the first electrode 130 operates as the transmission electrode and then at a subsequent time interval, the first electrode 130 operates as the reception electrode. At any given time, one electrode operates as the reception electrode and one electrode operates as the transmission electrode to form the first electric field 155.

Each electrode 130, 125 may comprise two terminal ends. For example, the first electrode 130 comprises a first end 300 and a second end 305. Similarly, the second electrode comprises a third end 310 and a fourth end 315. In various embodiments, the first and second electrodes 130, 125 may be positioned adjacent to each other.

According to various embodiments, and referring to FIGS. 2-4, the first electrode 130 and the second electrode 125 may be affixed to the container 205. For example, the first and second electrodes 130, 125 may be affixed to the outer surface 215 of the container 205, or the inner surface 210 of the container 205. In yet another configuration, the first and second electrodes 130, 125 may be formed within the sidewall 320 of the container 205.

In various embodiments, the first and second electrodes 130, 125 may be arranged to detect the substance 220 in the container 205. For example, the first and second electrodes 130, 125 may be positioned to form the first electric field 155 and have a capacitance that changes as the amount of the substance 220 changes. For example, when the container 205 is filled with the substance 220 to a first level (e.g., a maximum level), the first and second electrodes 130, 125 may have a first capacitance, and when the container is filled with substance 220 to a second level (e.g., a minimum level), the first and second electrodes 130, 125 may have a second capacitance that differs from the first capacitance.

According to various embodiments, the first electrode 130 may be affixed to the outer surface 215 of the container 205 and extends from the bottom portion 325 of the container 205 to the outer surface 215 of the sidewall 320. For example, the first end 300 of the first electrode 130 may be affixed to the bottom portion 325 and the second end 305 of the first electrode 130 may be affixed to the sidewall 320.

According to various embodiments, the second electrode 125 may be affixed to the outer surface 215 of the container 205. For example, the third end 310 of the second electrode 125 may be affixed to the sidewall 320 and positioned adjacent to the second end 305 of the first electrode 130 while the fourth end 315 is also affixed to the sidewall 320 and positioned upwards from and vertically aligned with the third end 310.

According to various embodiments, the first electrode 130 and the second electrode 125 are separated by a first gap 135 (e.g., 1 millimeter). For example, the first gap 135 may be defined by the space between one end (e.g., the second end 305) of the first electrode 130 and one end (e.g., the third end) of the second electrode 125. The location of the first gap 135 relative to the container 205 may vary. In other words, the first and second electrodes 130, 125 may be positioned such that the first gap 135 is located, for example, within a bottom-half of the container 205, at a half-way point, or within a top-half.

In various embodiments, the sensor system 100 detects when the substance 220 reaches a first level of interest IL1 in the container 205. The position of the first gap 135 may be related to the first level of interest IL1. For example, the position of the first gap 135, relative to the bottom portion 325 of the container 205, may correspond to the first level of interest IL1. In various embodiments, the sensor system 100 may experience the largest change in capacitance between the first and second electrodes 130, 125 when the a surface of the substance 220 reaches a level that is substantially aligned with the first gap 135, such as within a range from the first gap 135. For example, if the first gap 135 (and first level of interest IL1) is 10 millimeters (mm) from the bottom portion 325 of the container 205, then the sensor system 100 may experience the largest change in capacitance when the substance 220 is at levels between 8 mm and 12 mm from the bottom portion 325 of the container 205. In other words, the change in capacitance is greatest when the surface of the substance 220 is substantially aligned with the first gap 135, such as within a range of 5 millimeters or less from the first gap 135. Accordingly, as the amount of the substance 220 changes, the sensor system 100 may detect when the substance 220 is at or near the first level of interest IL1 by measuring the capacitance between the first and second electrodes 130, 125 and detecting a peak change in the measured capacitance.

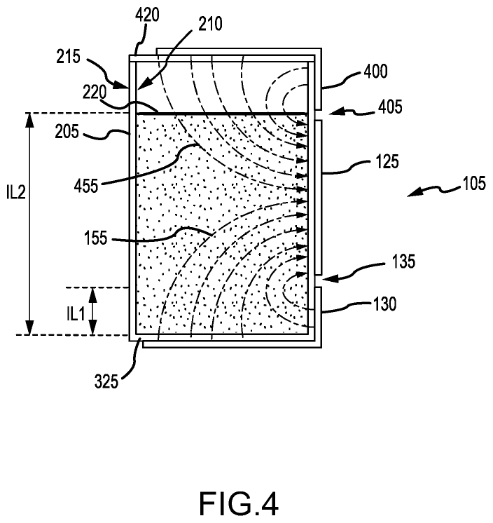

According to a second embodiment, and referring to FIG. 4, the sensor system 100 may comprise a third electrode 400 affixed to the top plate 420 and the sidewall 320 of the container 205. Similar to the first electrode 130, the third electrode 400 may be in communication with and positioned adjacent to the second electrode 125 to form a second electric field 455. For example, the third electrode 400, may operate as a reception electrode and the second electrode 125, may operate as a transmission electrode or vice versa. According to various embodiments, the operation of the second and third electrodes 125, 400 may be sequenced, wherein at one time interval, the second electrode 125 operates as the transmission electrode and then at a subsequent time interval, the second electrode 125 operates as the reception electrode. At any given time, one electrode operates as the reception electrode and one electrode operates as the transmission electrode to form the second electric field 455.

According to the present embodiment, the third electrode 400 and the second electrode 125 are separated by a second gap 405. For example, the second gap 405 may be defined by the space between one end of the third electrode 400 and one end (e.g., the fourth end 315) of the second electrode 125. The location of the second gap 405 relative to the container 205 may vary. In other words, the second and third electrodes 125, 400 may be positioned such that the second gap 405 is located within a top half of the container 205.

According to the present embodiment, the sensor system 100 detects when the substance 220 reaches a second level of interest IL2 in the container 205. The position of the second gap 405 may be related to the second level of interest IL2. For example, the position of the second gap 405, relative to the bottom portion 325 of the container 205, may correspond to the second level of interest IL2. In various embodiments, the sensor system 100 may experience the largest change in capacitance between the second and third electrodes 125, 400 when the substance 220 reaches a level that is within a particular range of the second gap 405. For example, if the second gap 405 (and second level of interest IL2) is 40 millimeters from the bottom portion 325 of the container 205, then the sensor system 100 may experience the largest change in capacitance when the substance 220 is at levels between 38 mm and 42 mm when measured from the bottom portion 325. In other words, the change in capacitance is greatest when the surface of the substance 220 is substantially aligned with the second gap 405, such as within a range of 5 millimeters or less from the second gap 405. Accordingly, as the amount of the substance 220 changes, the sensor system 100 may detect when the substance 220 is at or near the second level of interest IL2 by measuring the capacitance between the second and third electrodes 125, 400 and detecting a peak change in the measured capacitance.

In various embodiments, each of the first, second, and third electrodes 130, 125, 400 may comprise a single, continuous conductive element, or a plurality of conductive elements having the same polarity (and referred to collectively as an electrode). For example, each electrode may be formed using any suitable metal and/or other conductive material.

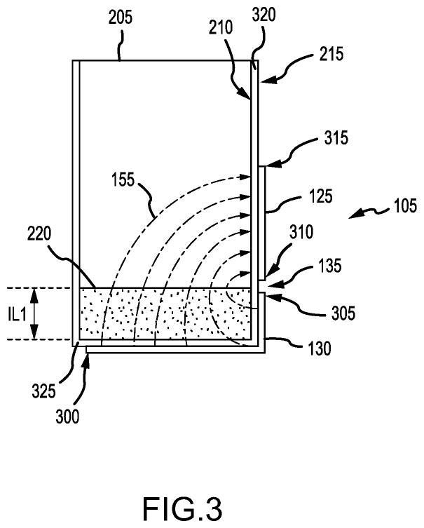

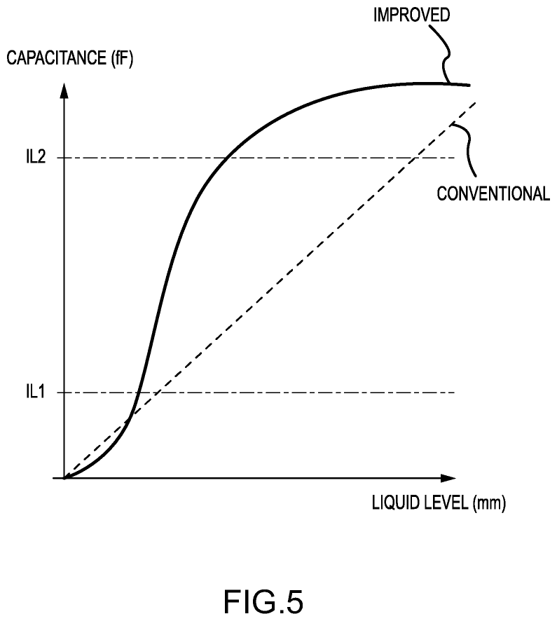

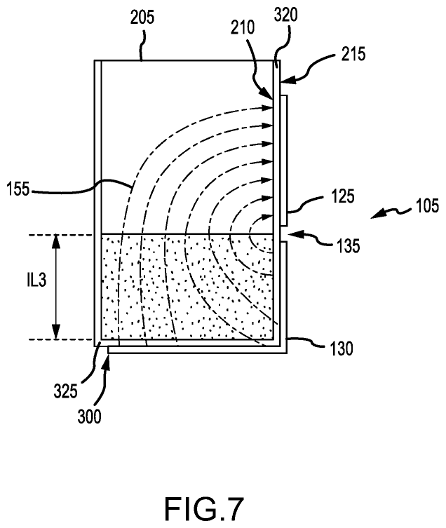

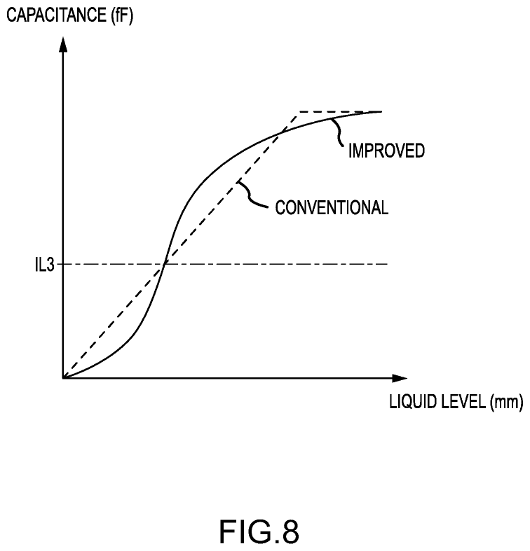

In various embodiments, the strength (density) of the electric field may change based on the position of the electrodes. For example, and referring to FIGS. 3, 5, 7 and 8, as the location of the gap changes, and corresponding level of interest changes, the peak change in capacitance (i.e., slope) also changes due to changes in the electric field. For example, in the present embodiments, the first and second electrodes 130, 125 and corresponding first gap 135 are arranged with different dimensions, such that the first gap 135 is located at different positions (heights) on the container 205. Specifically, the first level of interest IL1 (FIG. 3) is at a lower position on the container 205 (e.g., 10 mm from the bottom portion 325 of the container 205) than a third level of interest IL3 (FIG. 7, e.g., 20 mm from the bottom portion 325 of the container 205). It is observed that the slope of each waveform reaches its highest value at or near the level of interest. According to the present embodiments, when the first and second electrodes 130, 125 are arranged to provide the first level of interest IL1, a peak change in capacitance that occurs at the first level of interest IL1 (FIG. 5, e.g., IL1=191.2 fF) is less than a peak change in capacitance that occurs at the third level of interest IL3 (FIG. 8, e.g., IL3=242.6 fF) since the strength of the first electric field 155 increases as the position of the level of interest relative to the bottom 325 of the container 205 (and position of the gap 135 relative to the bottom 325 of the container 205) increases.

Referring again to FIG. 1, the detection circuit 110 may be coupled to the capacitive sensor 105 and configured to measure and/or detect changes in the capacitance of the capacitive sensor 105. The detection circuit 110 may comprise any suitable system or method for sensing changes in capacitance. For example, the detection circuit 110 may comprise an amplifier 165, an analog-to-digital converter (ADC) 145, and a logic circuit 150.

According to various embodiments, the detection circuit 110 may be connected to the capacitive sensor 105 at the input terminal Cin and the drive terminal Cdrv either directly or indirectly via the switches 115, 116, 117, 118.

The detection circuit 110 may be configured to have a preset internal capacitance or a variable internal capacitance. For example, the detection circuit 110 may comprise a variable capacitor 160 with an adjustable capacitance. The detection circuit 110 may further comprise an inverter 120 connected between a power source 170 and the capacitive sensor 105. The power source 170 may be connected to the capacitive sensor 105 via the drive terminal Cdrv.

The amplifier 165 may be configured to convert the capacitance at the input terminal Cin to a voltage and/or apply a gain the voltage. For example, the amplifier circuit 165 may comprise a differential amplifier comprising an inverting terminal (−) connected to the input terminal Cin and a non-inverting terminal (+) connected to a reference voltage, such as supplied by a voltage source 140. The amplifier 165 may be configured to measure a voltage difference between the inverting and non-inverting terminals. The amplifier 165 may also be configured to amplify a signal by applying a gain to the voltage difference and generate the output voltage Vout according to the voltage difference and/or the applied gain.

The ADC 145 may be connected to an output terminal of the amplifier 165 and configured to convert the output voltage Vout, to a digital value (i.e., AD value). According to various embodiments, as the capacitance of the capacitive element decreases, the corresponding digital value increases and vice versa. The ADC 145 may comprise any signal converter suitable for converting an analog signal to a digital signal.

The detection circuit 110 may further comprise a first feedback capacitor and a second feedback capacitor Cf2. The first feedback capacitor Cf1 may be electrically connected between a first output terminal and the inverting input terminal (−) of the amplifier 165, and the second feedback capacitor Cf2 may be electrically connected between a second output terminal and the non-verting input (+) of the amplifier 165. The first and second feedback capacitors Cf1, Cf2 may have the same capacitance. The first and second feedback capacitors Cf1, Cf2 may operate in conjunction with a first switch 175 and a second switch 180, respectively, to facilitate various operations and gain control of the amplifier 165.

The logic circuit 150 may receive the digital value from the ADC 145, interpret the values, and perform an appropriate response and/or produce an appropriate output signal according to the digital value. According to various embodiments, the logic circuit 150 may be configured to perform various computations, such as additional, subtraction, multiplication, and the like. For example, the logic circuit 150 may comprise logic gates and/or other circuitry to perform the desired computations. The logic circuit 150 may utilize the measured capacitance and/or the change in the measured capacitance to determine if a peak change in capacitance has occurred.

In operation, the sensor system 100 may be utilized to carry out a variety of detection schemes. For example, the sensor system 100 may detect the presence or absence of an object within a 3-dimensional space, the level of a substance in a container, and/or a volume of a substance in a container.

In various operations, and referring to FIGS. 1 and 4, the sensor system 100 detects the substance by measuring and/or detecting changes in the capacitance and the corresponding output voltage of the capacitive sensor 105 as a result of changes in the first electric field 155. In general, the substance 220 disrupts the first electric field 155 so changes in the amount or the level of the substance 220 in the container 205 will result in changes to the capacitance of the capacitive sensor 105. As the capacitance changes, the output voltage Vout also changes. As the output voltage Vout changes, it may be possible to quantify or otherwise estimate the amount and/or level of the substance 220 in the container 205.

According to one application, the sensor system 100 may be used in a host device (not shown), such a printer, and used to monitor levels of ink in an ink cartridge (not shown). For example, the sensor system 100 may be connected to and communicate with a controller (not shown), such as a microprocessor or other suitable processing circuit, used to control operations of the host device. The controller may utilize information from the sensor system 100 to determine the level of in the ink cartridge. If the level of ink reaches the first level of interest IL1, then the controller may provide an indication, such as displaying a message on the host device or providing a sound indicator (beeping), that the ink needs to be replenished. Similarly, when replenishing the ink, when the ink reaches the second level of interest IL2, the controller may provide an indication, such as a displaying a message or providing a sound indicator, that the ink cartridge is full.

According to the present application, the sensor system 100 is monitoring the capacitance and/or the change in capacitance of the capacitive sensor 105 and determining when a peak change occurs. When the peak change occurs, the sensor system 100 may report this event to the controller.

In an alternative application, the sensor system 100 may be used in a host device to measure a volume of a substance in a container based on the known dimensions (e.g., height, width, length) of the container, the dielectric constant of the substance, and the measured capacitance and/or changes in the capacitance and provide a desired feedback accordingly.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A capacitive sensor affixed to a container capable of holding a substance, comprising:
a first electrode affixed to the container and extending from a bottom portion of the container to a sidewall that is connected to and extends upwards from the bottom portion, wherein the first electrode comprises:
a first end affixed to the bottom portion of the container; and
a second end affixed to the sidewall of the container;
a second electrode affixed to the container and comprising:
a third end affixed to the sidewall of the container and positioned adjacent to the second end of the first electrode; and
a fourth end affixed to the sidewall of the container and positioned upwards from and vertically aligned with the third end;
wherein:
the first electrode and the second electrode form a first capacitance; and
the first electrode and the second electrode are separated by a first gap.

2. The capacitive sensor according to claim 1, wherein the first capacitance changes according to a height of a surface of the substance relative to the bottom portion.

3. The capacitive sensor according to claim 1, wherein a location of the first gap corresponds to a first indicator level.

4. The capacitive sensor according to claim 1, wherein a change in the first capacitance is greatest when a surface of the substance is substantially aligned with the first gap.

5. The capacitive sensor according to claim 1, wherein the first electrode has a first polarity and the second electrode has an opposite polarity.

6. The capacitive sensor according to claim 1, further comprising a third electrode affixed to the container and having the first polarity, wherein the third electrode comprises:
a fifth end affixed to a top portion, wherein the top portion is positioned substantially in parallel with and above the bottom portion; and
a sixth end affixed to the sidewall and adjacent to the fourth end.

7. The capacitive sensor according to claim 6, wherein:
the second electrode and the third electrode form a second capacitance; and
the fourth end and the sixth end are separated by a second gap.

8. The capacitive sensor according to claim 7, wherein a location of the second gap corresponds to a second indicator level.

9. The capacitive sensor according to claim 7, wherein a change in the second capacitance is greatest when a surface of the substance is substantially aligned with the second gap.

10. The capacitive sensor according to claim 1, wherein the first electrode comprises a plurality of same-polarity conductive elements.

11. The capacitive sensor according to claim 1, wherein the first electrode comprises a single, continuous conductive element.

12. A method for detecting a substance in a container using a capacitive sensor, comprising:
affixing the capacitive sensor to the container;
wherein the container comprises:
a bottom portion; and
a sidewall extending upward from the bottom portion;
wherein the capacitive sensor comprises:
a first electrode comprising:
a first end affixed to the bottom portion of the container; and
a second end affixed to the sidewall of the container; and
a second electrode comprising:
a third end affixed to the sidewall of the container and positioned adjacent to the second end of the first electrode; and
a fourth end affixed to the sidewall of the container and positioned upwards from and vertically aligned with the third end;
forming a capacitance between the first and second electrodes; and
detecting a change in the capacitance according to a height of a surface of the substance.

13. The method according to claim 12, wherein the second end and the third end are separated by a gap.

14. The method according to claim 13, wherein a location of the gap corresponds to an indicator level.

15. The method according to claim 14, wherein the change in the capacitance is greatest when the height of surface of the substance is within a 5 millimeter range from the gap.

16. A system for monitoring an amount of a liquid in a container, comprising:
a capacitive sensor affixed to the container;
wherein the container comprises:
a horizontal bottom plate; and
a sidewall extending upward from the horizontal bottom plate;
wherein the capacitive sensor comprises:
a first electrode affixed to the container and comprising:
a first end affixed to the horizontal bottom plate of the container; and
a second end affixed to the sidewall of the container; and
a second electrode affixed to the container and forming a first capacitance with the first electrode and comprising:
a third end affixed to the sidewall of the container and positioned adjacent to the second end of the first electrode, wherein the third end and the second end are separated by a first gap; and
a fourth end affixed to the sidewall of the container and positioned upwards from and vertically aligned with the third end; and
a detection circuit connected to the capacitive sensor and configured to:
measure the first capacitance;
compute a change in the first capacitance according to the measured capacitance; and
determine a height of a surface of the liquid according to the change in the first capacitance.

17. The system according to claim 16, wherein a location of the first gap corresponds to an indicator level.

18. The system according to claim 16, wherein the change in the first capacitance is greatest when the height of the surface of the liquid is substantially aligned with the first gap.

19. The system according to claim 16, further comprising a third electrode forming a second capacitance with the second electrode and comprising:
a fifth end affixed to a horizontal top plate, wherein the horizontal top plate is positioned in parallel with and above the horizontal bottom plate; and
a sixth end affixed to the sidewall and adjacent to the fourth end.

20. The system according to claim 19, wherein:
the fourth end and the sixth end are separated by a second gap; and
a change in the second capacitance is greatest when the height of the surface of the substance is substantially aligned with the second gap.
